(19) United States
(12) Patent Application Publication
(10) Pub. No.: US 2020/0320446 A1
(43) Pub. Date: Oct. 8, 2020

(54) METHOD AND SYSTEM FOR PLANNING MULTI-LEG TRIPS INCLUDING A FLIGHT LEG AND A GROUND LEG

(71) Applicant: AviationCloud A/S, Odense (DK)

(72) Inventors: Daniel Fentz Dahl, Odense (DK); Casper Kehlet Jensen, Odense (DK); Henrik Hansen, Odense (DK)

(73) Assignee: AviationCloud A/S, Odense (DK)

(21) Appl. No.: 16/373,259

(22) Filed: Apr. 2, 2019

(51) Int. Cl. G06Q 10/02

(52) U.S. Cl. CPC G06Q 10/025

(57) ABSTRACT

A method for planning a multi-leg trip involves obtaining, in a graphical user interface, trip data including a departure location, a departure airport, a destination airport, and a desired departure time; selecting a first ground leg of the multi-leg trip, the first ground leg connecting the departure location to the departure airport; obtaining a first estimated arrival time at the departure airport based on the desired departure time and the first ground leg; selecting a flight leg of the multi-leg trip, the flight leg connecting the departure airport and the destination airport. The method also involves obtaining a second estimated arrival time at the destination airport based on: the first estimated arrival time, an aircraft to be used for the flight leg, and a prevailing flight condition associated with the second flight leg; and presenting, in the graphical user interface, the second estimated arrival time.

### BACKGROUND

When planning a trip from a departure location to a destination location, predicting the duration of the trip may be desirable. In particular, it may be beneficial for a traveler to obtain a recommended departure time to arrive at the destination location at a specified time and/or to obtain an estimated time of arrival given a specified departure time. Today's route planning tools provide an estimate of the duration of a drive. However, because of various limitations and requirements of airplanes, the planning of a multi-leg trip that includes a flight is considerably more complex.

### SUMMARY

In general, in one aspect, one or more embodiments relate to a method for planning a multi-leg trip, the method comprising obtaining, in a graphical user interface, trip data comprising a departure location, a departure airport, a destination airport, and a desired departure time; selecting a first ground leg of the multi-leg trip, the first ground leg connecting the departure location to the departure airport; obtaining a first estimated arrival time at the departure airport based on the desired departure time and the first ground leg; and selecting a flight leg of the multi-leg trip, the flight leg connecting the departure airport and the destination airport. The method further comprises obtaining a second estimated arrival time at the destination airport based on: the first estimated arrival time, an aircraft to be used for the flight leg, and a prevailing flight condition associated with the second flight leg; and presenting, in the graphical user interface, the second estimated arrival time.

In general, in one aspect, one or more embodiments relate to a non-transitory computer readable medium including computer readable program code for causing a computer system to obtain, in a graphical user interface, trip data comprising a departure airport, a destination airport, a destination location and a desired arrival time; obtain a first prediction of a departure time at the departure airport to arrive at the destination location at the desired arrival time; calculate a first estimated arrival time at the destination location by: selecting a flight leg of the multi-leg trip, the flight leg connecting the departure airport to the destination airport; predicting an estimated arrival time at the destination airport based on: the first prediction of the departure time at the departure airport, an aircraft to be used for the flight leg, and a prevailing flight condition associated with the flight leg, selecting a ground leg of the multi-leg trip, the ground leg connecting the destination airport to the destination location; and predicting the first estimated arrival time at the destination location based on the estimated arrival time at the destination airport, and the ground leg. The computer readable program code further causes the computer system to determine an excessive discrepancy between the first estimated arrival time at the destination location and the desired arrival time, and based on the excessive discrepancy: obtain a second prediction of the departure time at the departure airport, wherein the second prediction is made to reduce the discrepancy; calculate a second estimated arrival time at the destination location based on the second prediction of the departure time; and identify an acceptable discrepancy between the second estimated arrival time at the destination location and the desired arrival time; and based on the acceptable discrepancy: present, in the graphical user interface, the second prediction of the departure time as a recommended departure time.

In general, in one aspect, one or more embodiments relate to a system for planning a multi-leg trip, the system comprising a computer processor; a graphical user interface; and instructions executing on the computer processor, causing the system to: obtain, in the graphical user interface, trip data comprising a departure location, a departure airport, a destination airport, and a desired arrival time; obtain a first prediction of a departure time at the departure location to arrive at the destination airport at the desired arrival time; calculate a first estimated arrival time at the destination airport by: selecting a ground leg of the multi-leg trip, the ground leg connecting the departure location to the departure airport; predicting an estimated arrival time at the departure airport based on the first prediction of the departure time at the departure location and the ground leg; selecting a flight leg of the multi-leg trip, the flight leg connecting the departure airport to the destination airport; predicting the first estimated arrival time at the destination airport based on: the estimated arrival time at the departure airport, an aircraft to be used for the flight leg, and a prevailing flight condition associated with the flight leg. The instructions further cause the system to determine an excessive discrepancy between the first estimated arrival time at the destination airport and the desired arrival time, and based on the excessive discrepancy: obtain a second prediction of the departure time at the departure location, wherein the second prediction is made to reduce the discrepancy; calculate a second estimated arrival time at the destination airport based on the second prediction of the departure time; and identify an acceptable discrepancy between the second estimated arrival time at the destination location and the desired arrival time; and based on the acceptable discrepancy: present, in the graphical user interface, the second prediction of the departure time as a recommended departure time.

Other aspects of the disclosed invention will be apparent from the following description and the appended claims.

### BRIEF DESCRIPTION OF DRAWINGS

FIG. 1 shows a block diagram of a system for planning multi-leg trips, in accordance with one or more embodiments of the disclosure.

FIG. 2A shows a flowchart describing a method for planning a multi-leg trip in a forward direction, in accordance with one or more embodiments of the disclosure.

FIG. 2B shows a flowchart describing a method for planning a multi-leg trip in a backward direction, in accordance with one or more embodiments of the disclosure.

FIG. 3 shows a flowchart describing a method for obtaining data describing the multi-leg trip, in accordance with one or more embodiments of the disclosure.

FIG. 4A shows a flowchart describing a method for determining an estimated duration of a drive, in accordance with one or more embodiments of the disclosure.

FIG. 4B shows a flowchart describing a method for determining an estimated duration of a flight, in accordance with one or more embodiments of the disclosure.

FIG. 5 shows an example of a multi-leg trip, in accordance with one or more embodiments of the disclosure.

FIGS. 6A, 6B, and 6C show examples of user interface screens, in accordance with one or more embodiments of the disclosure.

FIGS. 7A and 7B show computing systems in accordance with one or more embodiments of the disclosures.

### DETAILED DESCRIPTION

Specific embodiments of the disclosed technology will now be described in detail with reference to the accompanying figures. Like elements in the various figures may be denoted by like reference numerals and/or like names for consistency.

The following detailed description is merely exemplary in nature and is not intended to limit the disclosed technology or the application and uses of the disclosed technology. Furthermore, there is no intention to be bound by any expressed or implied theory presented in the preceding technical field, background, brief summary or the following detailed description.

In the following detailed description of embodiments of the disclosed technology, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Various embodiments of the disclosure enable the planning of multi-leg trips. In general, a multi-leg trip is a trip involving more than one leg separated by a planned stop, whereby at least one leg includes at least one flyable leg connecting a departure airport and a destination airport. The multi-leg trip may include multiple modes of transportation for each leg, whereby one mode of transportation is aircraft and another mode is a car, bus, or other motorized vehicle. A flight leg is a leg involving an aircraft in the air and a ground leg is a leg involving a motorized vehicle. Additional legs may connect a departure location with the departure airport and/or the destination airport with a destination location by a ground leg using the motorized vehicle. In other words, the multi-leg trip may start at the departure location and end at the destination location, whereby the departure location and the destination location are not the same as the departure airport and the destination airport.

A traveler may use the planning of a multi-leg trip to prepare for a trip from the departure location, via departure airport and destination airport to the destination location. Embodiments of the disclosure may be particularly beneficial when planning trips that involve a general aviation (i.e., non-airline) flight. A traveler may use embodiments of the disclosure to obtain an estimated arrival time at a destination location, given a specified departure time at a departure location. Similarly, a traveler may use embodiments of the disclosure to obtain a recommended departure time at a departure location, given a desired arrival time at a destination location. Embodiments of the disclosure provide an estimated arrival time or a recommended departure time, even though multi-leg trips involving general aviation flights are complex to plan and even though driving involves undefined traffic patterns. The complexity of the aviation flight is due to considerations of fuel stops, and/or when accommodating preferences or limitations, such as the performance characteristics of the aircraft, the choice of departure and/or destination airport, the number of passengers, the weight of the passengers and cargo, etc. While the subsequent description covers multi-leg trips involving at least one leg that is a flight and another leg that is not a flight, those skilled in the art will appreciate that embodiments of the disclosure may also be used to plan a trip that involves only a flight. More specifically, a flight may include multiple legs, separated by, for example, one or more fuel stops.

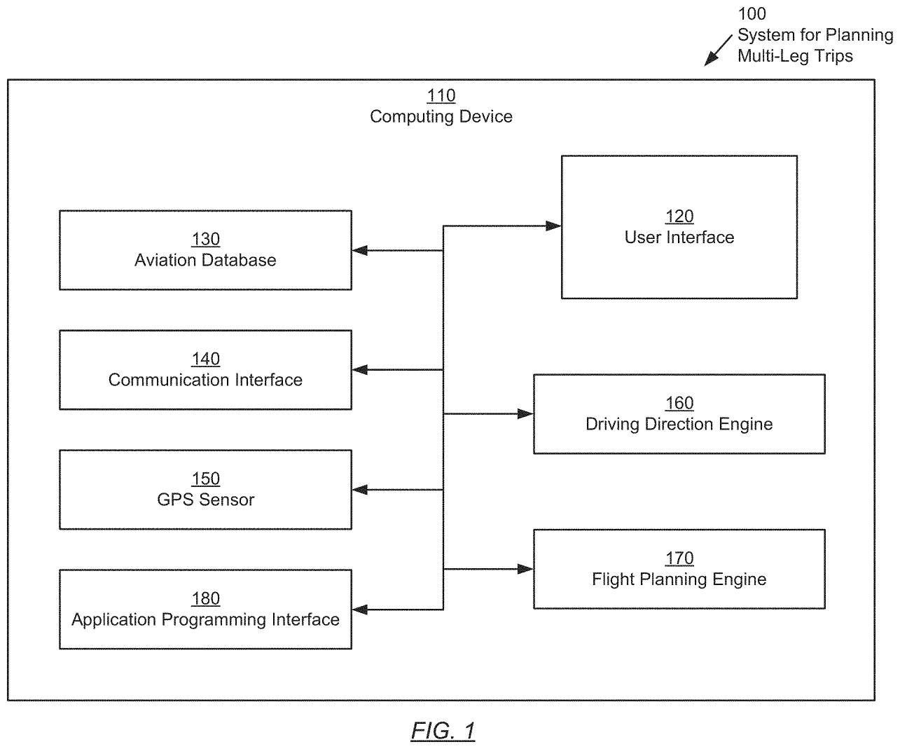

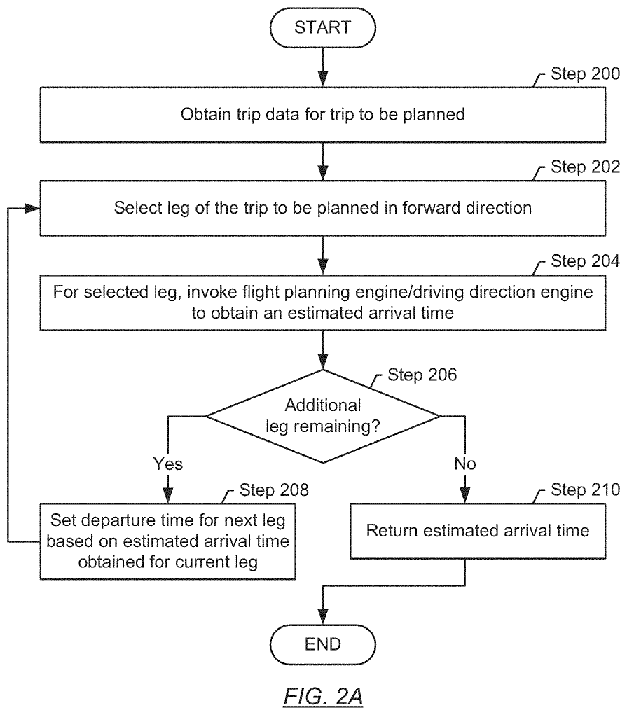

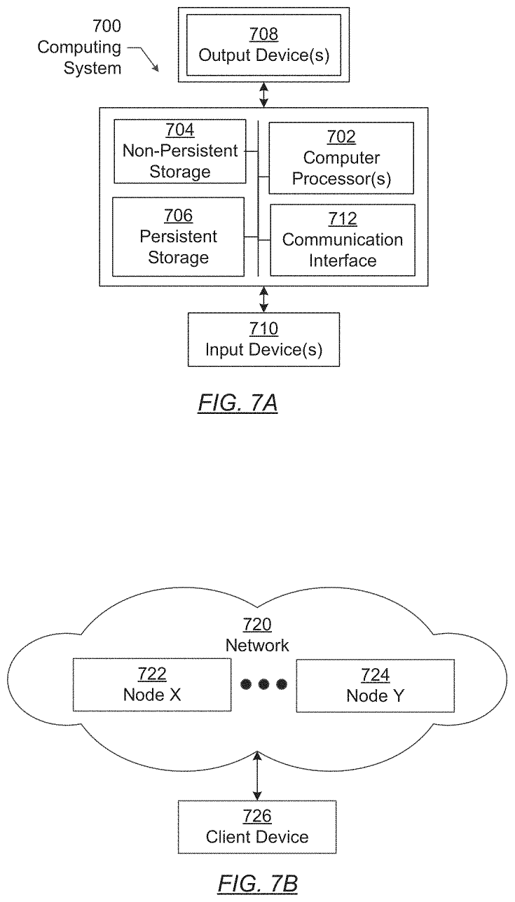

Turning to FIG. 1, a system for planning multi-leg trips, in accordance with one or more embodiments, is shown. The system (100) may include a computing device (110). The computing device (110) may be a non-portable or portable computing device, for example, a desktop personal computer, tablet computer, a smartphone, or a laptop. Exemplary configurations of computing devices in accordance with one or more embodiments of the disclosure are described below, with reference to FIGS. 7A and 7B. The computing device (110), in accordance with one or more embodiments of the disclosure, is configured to execute a set of machine-readable instructions (stored on a computer-readable medium) which, when executed by the computing device (110), perform one or more of the operations described in the flowcharts of FIGS. 2A, 2B, 3, 4A, and/or 4B.

The computing device (110) may implement, include and/or interface with a user interface (120), an aviation database (130), a communication interface (140), a GPS sensor (150), a driving direction engine (160) a flight planning engine (170) and an application programming interface (180). Each of these components is subsequently described.

The user interface (120), in accordance with one or more embodiments, supports input to the system (100) by a user, and output by the system (100) to the user. The user interface (120) may, thus, include one or more input devices such as a keyboard, a touch screen, a mouse, and/or a touchpad, and an output device such as a display. The display may be a screen, such as a liquid crystal display (LCD), light emitting diode (LED) or organic LED (OLED) screen or any other type of display that supports visual content to be shown to a user. Specialized display technologies or accessories may further be used, e.g., screens that are customized for nighttime use. The display may be used as the output interface to a user (e.g. a pilot) and may display content related to a trip being planned, such as maps, text describing the trip, etc. Some of the displayed content may be editable to enable the user to build or edit a trip.

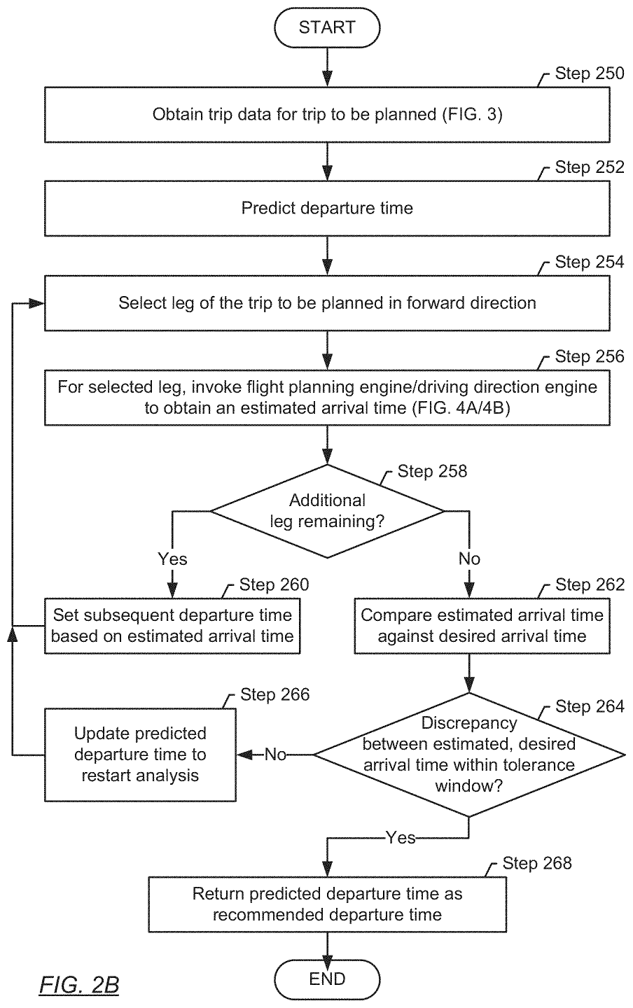

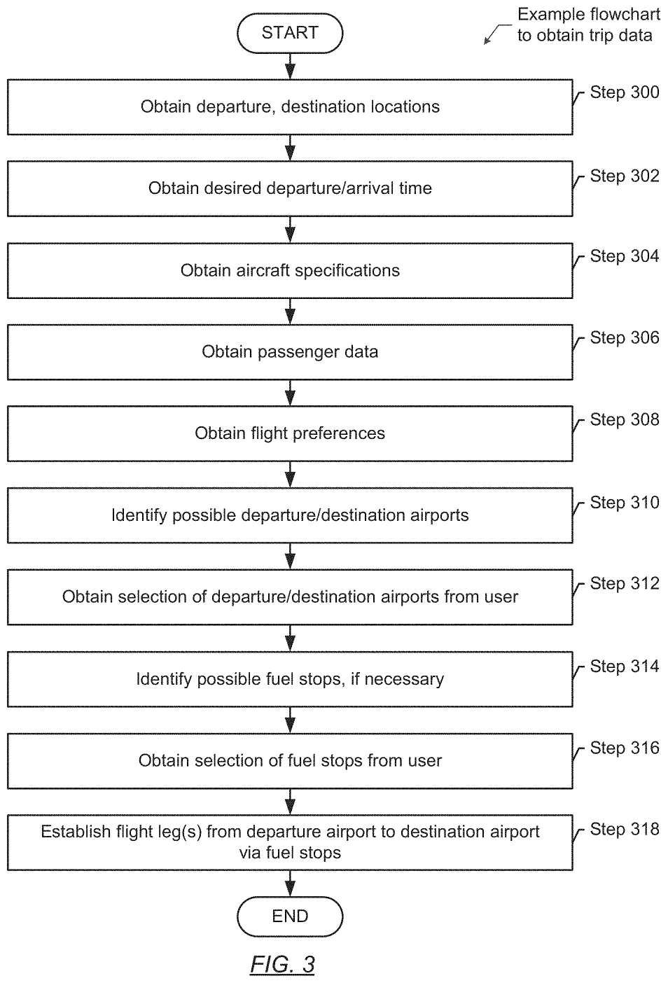

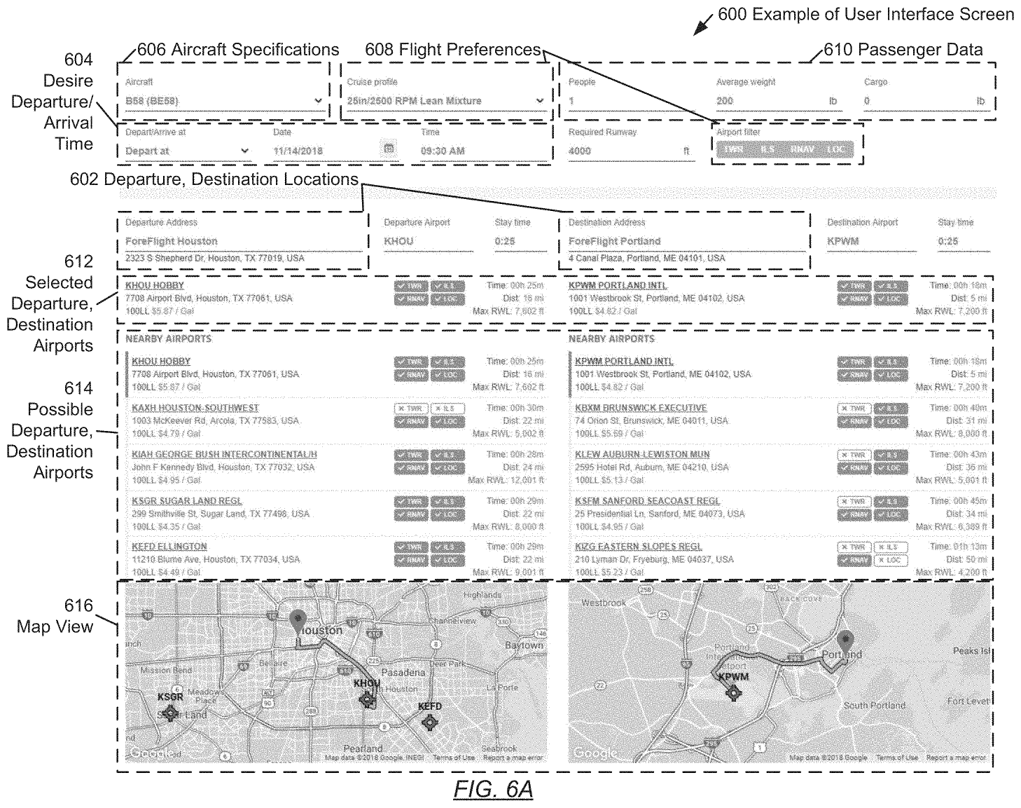

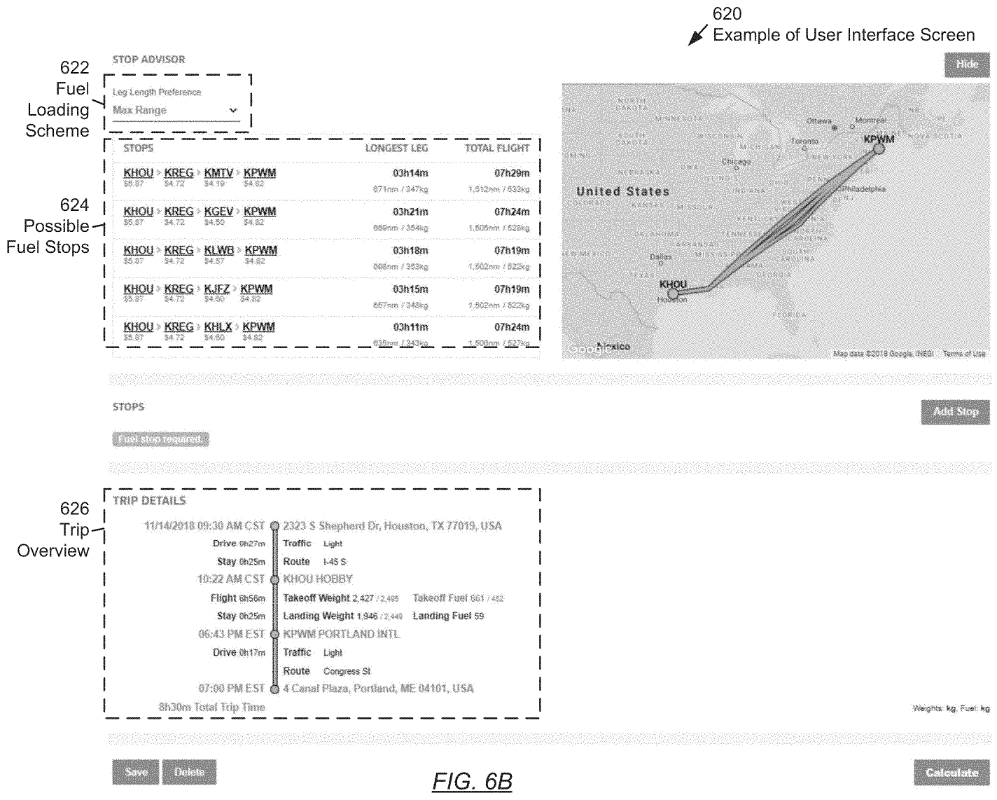

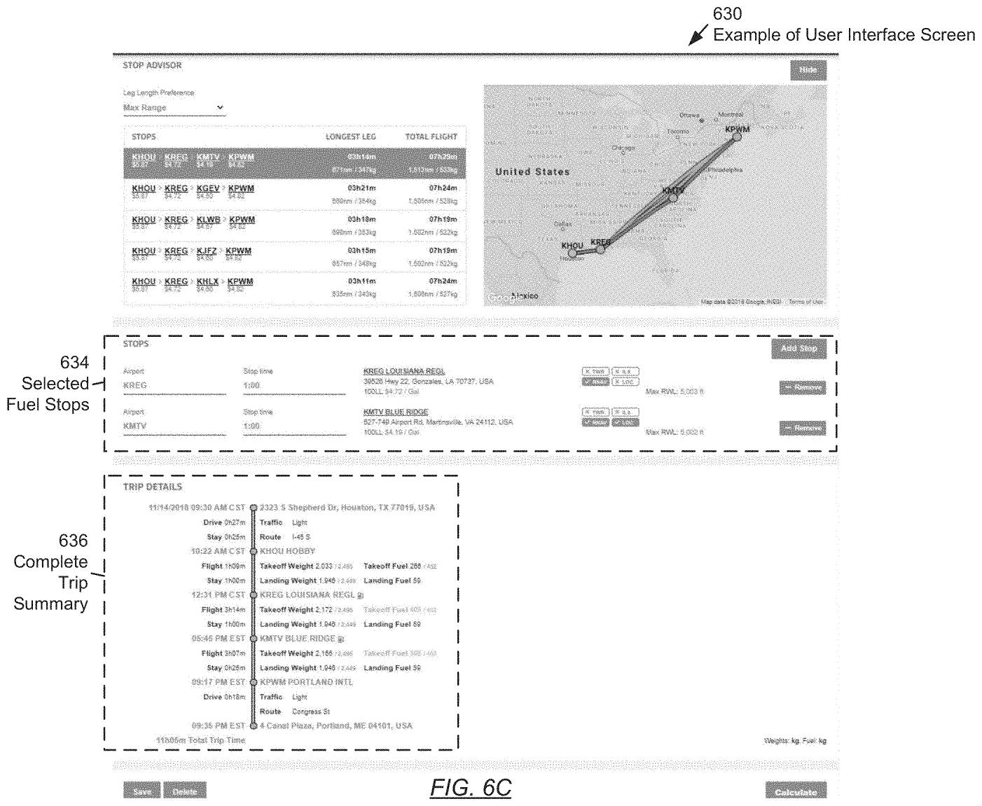

The user interface may accommodate any content associated with a trip, including input fields for entering content describing the trip, and/or output elements for displaying content describing the trip. Input elements may be on-screen drop-down menus, checkboxes, free-text fields, etc. The input elements may be configured to receive information including, but not limited to, departure and destination locations, departure and destination airports, a desired departure or arrival time, a selection of an aircraft to be used along with aircraft specifications including the selected cruise profile, passenger data, a fuel loading scheme, etc. The output elements may include text and/or graphics intended to inform the user about the configuration of the trip being planned. Displayed information about the trip may include, but is not limited to, possible departure and/or destination airports from which the user may choose, possible fuel stops from which the user may choose, a map visualization of the drive from a departure location to a departure airport, and/or from a destination airport to a destination location, a map visualization of the planned flight from the departure airport to the destination airport, a timeline for the trip, etc. In one or more embodiments, the user interface is interactive. A user may make selections to plan a trip using the input elements of the user interface. In response to the user's selections, the output elements of the user interface are updated to inform the user about the planned trip. Subsequently, the user may choose to modify the trip until satisfied with the planned trip. Various examples of content displayed to a user are provided in FIGS. 6A, 6B, and 6C. Further, FIG. 3 provides a description of various steps performed by or in conjunction with the user interface.

The aviation database (130), in accordance with one or more embodiments, provides information necessary for the planning of a trip that involves a flight. The information in the aviation database may include but is not limited to maps, airport information, flight conditions (including weather, restrictions, delays, etc.) and aircraft information (including performance data). The aviation database may be local, e.g., stored on a hard drive or in flash memory, or remote, e.g., stored on a server or provided by a cloud-based service. A remotely stored database may be accessed via the communication interface (140). Further, one or more aviation databases (130) may exist. Specifically, one database may be dedicated to weather data, another database may be dedicated to aircraft information, etc.

The communication interface (140), in accordance with one or more embodiments, includes software and hardware components that perform communication operations for the computing device (110) to communicate with other computing devices such as remote servers, cloud-based services, etc. The communication interface may be any kind of wired or wireless network interface. In one or more embodiments, aviation data that changes frequently, e.g., information about winds aloft, weather phenomena, airspace congestion, and/or fueling information, etc., is obtained via the communication interface (140).

The GPS sensor (150), in accordance with one or more embodiments, includes a hardware sensor configured to determine a current location. The GPS sensor may be a sensor built into the computing device (110) or may be an external sensor that may be installed on an aircraft or vehicle being used.

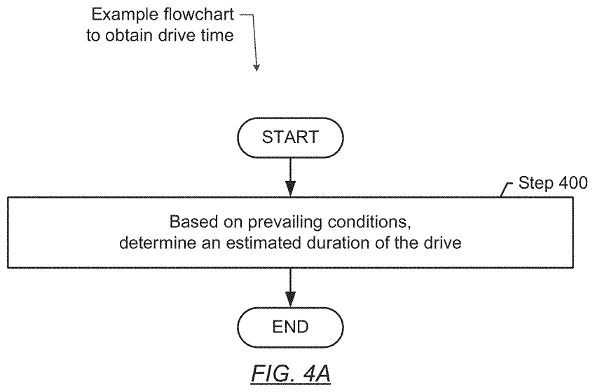

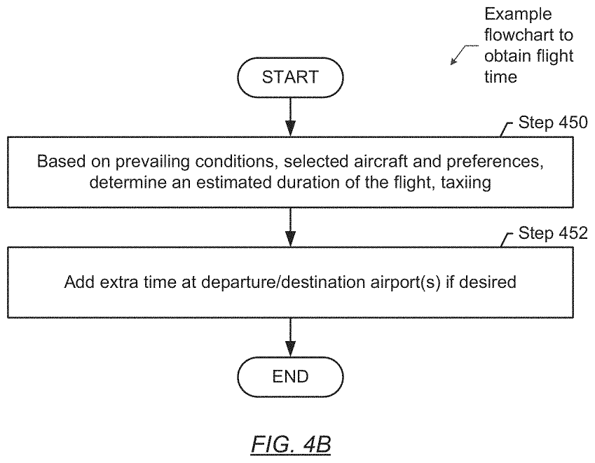

The driving direction engine (160), in accordance with one or more embodiments, is used to plan legs of a trip that involve a drive from one location to another location. The driving direction engine (160) may include software instructions that compute at least an estimate of the duration of the drive, based on the departure and destination locations of the drive. Other factors may be considered in addition. For example, the time of day and traffic may be considered. The operations performed by the driving direction engine (160) are described below with reference to the flowcharts of FIGS. 2A, 2B, and 4A. While the driving direction engine (160) is described as planning a drive using a motor vehicle, the driving direction engine (160) may be used for any mode of transportation and may perform the described operations for cab rides, bus rides, shuttle rides, walks, etc.

The flight planning engine (170), in accordance with one or more embodiments, is used to plan legs of a trip that is a flight from one location to another location. The flight planning engine (170) may include software instructions that compute at least an estimate of the duration of the flight, based on the departure and destination airports. Other factors may be considered in addition. For example, the weather, flight restrictions, airspace congestion, etc., which may result in a longer duration of the flight, may require detours, and/or additional fuel stops, may be considered. The operations performed by the flight planning engine (170) are described below with reference to the flowcharts of FIGS. 2A, 2B, and 4B. The flight planning engine may perform additional functions that are not described here.

The application programming interface (API) (180) may be used to share trip planning results with other systems or methods. Accordingly, the planning of multi-leg trips may be provided as a service that may be called remotely by another application.

While FIG. 1 shows a configuration of components, other configurations may be used without departing from the scope of the disclosure. For example, various components may be combined to create a single component. As another example, the functionality performed by a single component may be performed by two or more components. Accordingly, for at least the above-recited reasons, embodiments of the disclosed invention should not be considered limited to the specific arrangements of components and/or elements shown in FIG. 1.

FIGS. 2A, 2B, 3, 4A, and 4B show flowcharts in accordance with one or more embodiments of the disclosure. While the various steps in these flowcharts are presented and described sequentially, one of ordinary skill will appreciate that some or all of these steps may be executed in different orders, may be combined or omitted, and some or all of the steps may be executed in parallel. In one embodiment of the disclosure, the steps shown in FIGS. 2A, 2B, 3, 4A, and 4B may be performed in parallel with any other steps shown in FIGS. 2A, 2B, 3, 4A, and 4B, without departing from the disclosure.

The methods of FIGS. 2A, 2B, 3, 4A, and 4B may be performed when a user, e.g., a traveler, an assistant, a flight crew member, etc., accesses the system (100) to plan a trip.

Turning to FIG. 2A, a flowchart describing a method for planning a multi-leg trip in a forward direction, in accordance with one or more embodiments of the disclosure, is shown. The planning in a forward direction may enable a user to determine an estimated arrival time at a destination location, given a desired departure time at a departure location. Accordingly, the method of FIG. 2A may be invoked whenever a user intends to perform the planning of a trip in a forward direction. The planning of the trip in a forward direction, in accordance with an embodiment of the disclosure, is performed by determining a duration of each leg of the trip, with the legs in sequential order from first leg to last leg. Based on the desired departure time at the departure location, arrival times may thus be determined for each of the legs. The arrival time for the last leg is the estimated arrival time at the destination location, which may be provided to the user. The steps for performing the planning of a trip in a forward direction are subsequently described.

In Step 200, trip data is obtained. The trip data may include any information to be used to determine the duration of the trip, as described below. The trip data may include a specification of each leg of the trip. Further, the trip data may specify a desired departure time. The trip data may be incrementally obtained in an interactive manner. The user interface receives the user's initial selections. Based on these initial selections, additional selections may be made until the trip is fully specified. The selections may be made in a user interface equipped with dropdown menus, checkboxes, etc. The details regarding obtaining trip data are provided in FIG. 3. Further, examples of user interface screens, illustrating how trip data may be entered or selected by a user are provided FIGS. 6A, 6B, and 6C. After completion of Step 200, the trip data may include a specification of all legs of the trip to be planned.

In Step 202, a leg of the trip to be planned is selected in a forward direction. For example, for a trip that includes three legs, the first leg from the departure location to an intermediate location is selected first. Later, when Step 202 is executed a second time, the second leg may be selected, and finally the third leg may be selected.

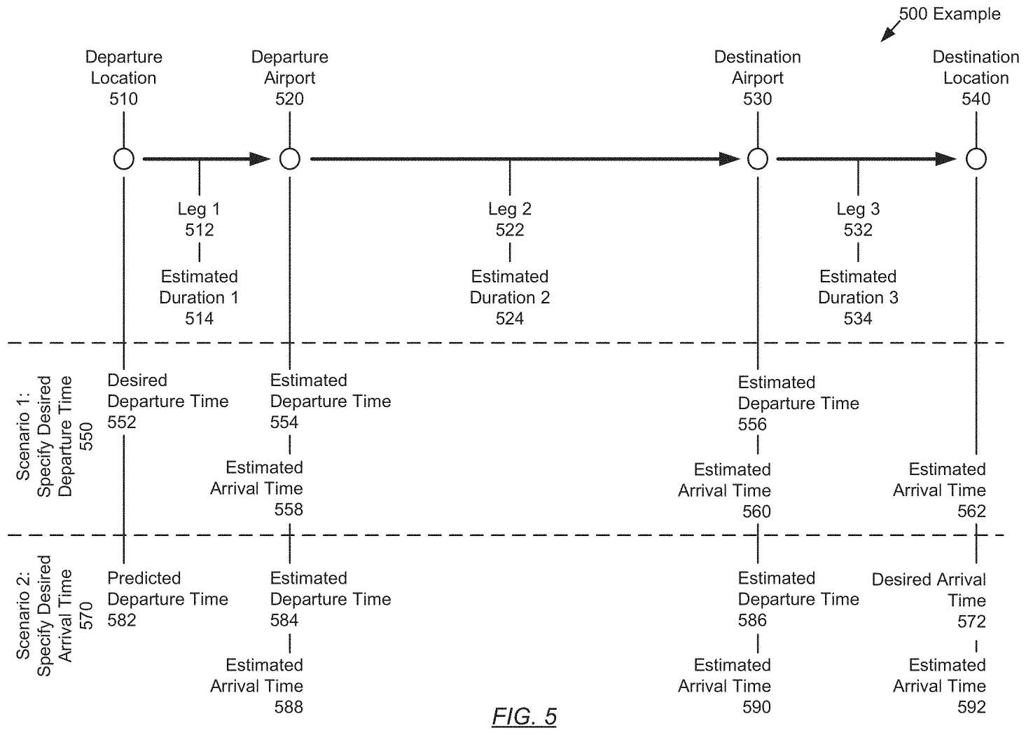

In Step 204, for the selected leg, the flight planning engine (if the selected leg involves a flight) or the driving direction engine (if the selected leg involves a drive) is invoked. The flight planning engine/driving direction engine provides an estimate of the arrival time for the selected leg, based on a departure time for the selected leg, in accordance with one or more embodiments. For the first leg of a trip, the departure time may be specified by the user. For subsequent legs, the departure time may be based on an arrival time associated with the preceding leg. A detailed description of Step 204 is provided in FIG. 4A (driving direction engine) and FIG. 4B (flight planning engine). Further, the example shown in FIG. 5 illustrates the execution of Step 204.

In Step 206, it is determined whether additional legs of the trip to be planned are remaining. If an additional leg is remaining, the execution of the method may proceed with Step 208. If no additional leg is remaining, the execution of the method may proceed with Step 210.

In Step 208, the departure time for the for the next leg of the trip is set based on the estimated arrival time obtained in Step 204. A buffer (e.g., a five minute layover or any other time span) may be inserted between the estimated arrival time for the current leg and the estimated departure time for the next leg. The estimated departure time for the next leg may, thus, be the estimated arrival time for the preceding leg plus a buffer time to accommodate any delay between arrival and subsequent departure. In other words, the multileg trip plans for specific patterns regarding the time and the day in which the user processes each leg, and, thus, accommodates the varying traffic patterns throughout the day even when the trip spans multiple days. Subsequently, the execution of the method may return to Step 202 to select the next leg for processing.

In Step 210, the estimated arrival time is reported. The estimated arrival time may be displayed in the user interface. In addition, a timeline of the trip may be displayed. This timeline may show the stops of the trip (including departure and arrival location), and the associated departure and/or arrival times. Additional content such as the length and/or travel duration of legs of the trip, and flight-leg specific data such as fuel, takeoff and landing weight may be displayed in the timeline. An example of a timeline is shown in FIG. 6C.

Turning to FIG. 2B, a flowchart describing a method for planning a multi-leg trip in a backward direction, in accordance with one or more embodiments of the disclosure, is shown. The planning in a backward direction may enable a user to determine a recommended departure time at a departure location, given a desired arrival time at a destination location. Accordingly, the method of FIG. 2B may be invoked whenever a user intends to perform the planning of a trip in a backward direction. The planning of the trip in a backward direction, in accordance with an embodiment of the disclosure, is performed by determining a duration of each leg, with the legs in sequential order from first leg to last leg. A recommended departure time may be initially predicted, and an estimated arrival time may be obtained based on the predicted departure time. The estimated arrival time may be compared to the desired arrival time, and subsequently the predicted departure time may be updated until the estimated arrival time at the destination location matches the desired arrival time. Subsequently, the predicted departure time that resulted in an estimated arrival time close to the desired arrival time may be provided to the user. The steps for performing the planning of a trip in a backward direction are subsequently described.

In Step 250, trip data is obtained. The trip data may include any information to be used to determine the duration of the trip, as described below. The trip data may include a specification of each leg of the trip. Further, the trip data may specify a desired arrival time. The trip data may be incrementally obtained in an interactive manner. The user interface receives the user's initial selections. Based on these initial selections, additional selections may be made until the trip is fully specified. The selections may be made in a user interface equipped with dropdown menus, checkboxes, etc. The details regarding obtaining trip data are provided in FIG. 3. Further, examples of user interface screens, illustrating how trip data may be entered or selected by a user are provided FIGS. 6A, 6B, and 6C. After completion of Step 250, the trip data may include a specification of all legs of the trip to be planned.

In Step 252, a departure time at the departure location is predicted. The prediction may be a random guess or a systematic prediction. The systematic prediction may be made based on certain assumptions and/or information that is initially available. For example, in one scenario, a travel time is obtained based on the distance between departure location and destination location and an assumed travel speed. To obtain a more accurate prediction, additional factors may be considered. In one scenario, the legs of the trip may be individually considered. Specifically, a lower travel speed, typical for ground transportation, may be assumed for a ground leg, and a higher travel speed, typical for an aircraft, may be assumed for a flight leg. If the mode of ground transportation is known, it may be considered. For example, a lower travel speed may be assumed for a ground leg being completed using public transportation, in comparison to a ground leg being completed using a car. Further, if a preferred cruise profile for the aircraft to be used is known, a more accurate travel speed may be assumed for the prediction. Other refinements may be applied when making the prediction, without departing from the disclosure. Based on the above discussion, consider an example in which the desired arrival time is 4 PM. The trip involves a short flight and a commute to the departure airport. In the example, it is assumed that the duration of the trip is two hours. Accordingly, the predicted departure time is 2 PM. As further discussed below, obtaining an accurate prediction of the departure time may not be particularly relevant, because the predicted departure time merely serves as a starting point for the algorithm.

In Step 254, a leg of the trip to be planned is selected in a forward direction. For example, for a trip that includes three legs, the first leg from the departure location to an intermediate location is selected first. Later, when Step 254 is executed a second time, the second leg may be selected, and finally the third leg may be selected.

In Step 256, for the selected leg, the flight planning engine (if the selected leg involves a flight) or the driving direction engine (if the selected leg involves a drive) is invoked. The flight planning engine/driving direction engine provides an estimate of the arrival time for the selected leg, based on a departure time for the selected leg, in accordance with one or more embodiments. For the first leg of a trip, the departure time may be the predicted departure time. For subsequent legs, the departure time may be based on an arrival time associated with the preceding leg. A detailed description of Step 204 is provided in FIG. 4A (driving direction engine) and FIG. 4B (flight planning engine). Further, the example shown in FIG. 5 illustrates the execution of Step 204.

In Step 258, it is determined whether additional legs of the trip to be planned are remaining. If an additional leg is remaining, the execution of the method may proceed with Step 260. If no additional leg is remaining, the execution of the method may proceed with Step 262.

In Step 260, the departure time for the next leg of the trip is set based on the estimated arrival time obtained in Step 256. A buffer (e.g., a five minute layover or any other time span) may be inserted between the estimated arrival time for the current leg and the estimated departure time for the next leg. Subsequently the execution of the method may return to Step 254 to select the next leg for processing.

In Step 262, the estimated arrival time obtained in Step 256 is compared against the desired arrival time specified in Step 250 to obtain a discrepancy between the estimated arrival time and the desired arrival time.

In Step 264, if the discrepancy exceeds a tolerance window, the execution of the method may proceed with Step 266. If the discrepancy is within the tolerance window, it may be concluded that the predicted departure time is sufficiently accurate, and the method may proceed with the execution of Step 268. The tolerance window may be customizable. The tolerance window may be, for example, 15 minutes, 30 minute, one hours, or any other desired timespan.

In Step 266, an updated predicted departure time is obtained to restart the described analysis. The updated predicted departure time may be selected to reduce the discrepancy computed in Step 262. More specifically, the updated predicted departure time may be obtained by subtracting the discrepancy from the previously predicted departure time. Consider a scenario in which the estimated arrival time is one hour earlier than the desired arrival time, while the tolerance window allows a maximum discrepancy of 15 minutes. In this scenario, the predicted departure time to be used for the next analysis cycle may be shifted one hour backwards. The method may then proceed with Step 254, starting with the first leg of the trip.

In Step 268, the predicted departure time is reported as the recommended departure time. The recommended departure time may be displayed in the user interface. In addition, a timeline of the trip may be displayed. This timeline may show the stops of the trip (including departure and arrival location), and the associated departure and/or arrival times. Additional content such as the length and/or travel duration of legs of the trip, and flight-leg specific data such as fuel, takeoff and landing weight may be displayed in the timeline. An example of a timeline is shown in FIG. 6C.

Turning to FIG. 3, a flowchart describing a method for obtaining data describing a multi-leg trip, in accordance with one or more embodiments of the disclosure, is shown.

In Step 300, departure and destination locations for the trip to be planned are obtained. Departure and destination locations may be obtained via a user interface, as illustrated in FIGS. 6A, 6B, and 6C. A departure/destination location may be a street address, a business, a landmark, etc. Geocoding may be used to convert an address into coordinates to be used in the subsequent steps. Further, if the current location of the user is used as the departure location, the current location provided by a GPS sensor may be used to set the departure location.

In Step 302, the desired departure/arrival time is obtained. A desired departure time is obtained if the method of FIG. 3 is invoked by Step 200 of FIG. 2A, and a desired arrival time is obtained if the method of FIG. 3 is invoked by Step 250 of FIG. 2B. The desired departure/arrival time may be obtained via a user interface, as illustrated in FIGS. 6A, 6B, and 6C.

In Step 304, aircraft specifications are obtained. Aircraft specifications may include performance data such as airspeeds, fuel requirements, payload, runway requirements, etc. The obtained aircraft specifications may subsequently be used to establish the flight leg(s) of the trip. Aircraft specifications may be obtained via a user interface, as illustrated in FIGS. 6A, 6B, and 6C.

In Step 306, passenger data is obtained. Passenger data may include the number of passengers, weight, luggage, etc. Passenger data may be obtained via a user interface, as illustrated in FIGS. 6A, 6B, and 6C.

In Step 308, flight preferences are obtained. Flight preferences may include services available at airports to be used. For example, a flight preference may be the availability of an instrument landing system, the availability of a control tower, etc. Flight preferences may be obtained via a user interface, as illustrated in FIGS. 6A, 6B, and 6C.

In Step 310, possible departure and destination airports are identified. Possible departure/destination airports may be identified based on various criteria, including but not limited to: (i) distance from departure/destination locations; (ii) operating hours; (iii) fuel availability; (iv) matching of aircraft specifications (e.g., runway length sufficient); (v) availability of services specified by the flight preferences; and/or (vi) airport fees. A list of possible departure/destination airports compatible with these criteria may be provided. The list of possible departure/destination airports may be displayed to the user in the user interface. The list may be ordered, as subsequently discussed. The ranking of the possible departure/destination airports may be performed using scores. For each of the criteria being used to evaluate an airport, an individual score may be calculated, based on how well the airport meets the criterion. For example, a higher score may be assigned for a departure airport that is closer to a departure location, in comparison to an airport that is more remote. Similarly, a lower airport fee may result in a higher score, etc. A total score for an airport may be computed by combining the individual scores, obtained for the various criteria. A scaling of the individual scores may be performed to obtain a weighting. The weighting may emphasize more important criteria over less important criteria. Subsequently, the total score of an airport may be compared to total scores of other airports to obtain a ranking of the airports. Based on the total scores, the airports may be displayed in an ordered list. The highest-ranked airport may be displayed at the top of the list. An example of available departure/destination airports, displayed in an ordered list, is provided in FIGS. 6A, 6B, and 6C.

In Step 312, a selection of the departure/destination airport is obtained from the user. The user may select from the airports identified in Step 310. Alternatively, the user may specify a different airport.

In Step 314, fuel stops are identified, if necessary. Fuel consumption data (which may be affected by the aircraft specifications, passenger data, and or flight preferences), the distance between departure and destination airports, and weather may be considered when determining whether fuel stops are necessary. Various factors may be considered when determining the fuel stops: (i) preferred fuel loading schemes (e.g., top off at each stop vs minimum required to next stop vs at least one hour reserve); (ii) fuel availability and cost; (iii) runway characteristics; (iv) availability of services; (v) airport fees; (vi) potential fuel tankering, if economical, etc. Based on the above factors, sets of potential fuel stops may be proposed to the user. In one embodiment of the disclosure, the identification of fuel stops is performed using a ranking. For the ranking, all fuel stops that meet certain criteria may be considered initially. These criteria may include, but are not limited to, location (the fuel stop has to be reachable, thus establishing a geographical window based on a range of the aircraft), fuel availability (the specific fuel required by the aircraft, e.g., 100LL or JET-A, has to be available), and available runway characteristics (runway length has to be sufficient for aircraft). The fuel stops are subsequently ranked based on one or more criteria. For example, a higher score may be assigned for a fuel stop where the fuel cost is lower, where the airport fees are lower, etc. A total score for a fuel stop airport may be computed by combining the scores obtained for the various criteria. A scaling of the individual scores may be performed to obtain a weighting. The weighting may emphasize more important criteria over less important criteria. Subsequently, the total score of a fuel stop may be compared to total scores of other fuel stops to obtain a ranking of the fuel stops. An example of sets of potential fuel stops is provided in FIGS. 6B and 6C.

In Step 316, a selection of the set of fuel stops to be used for the flight is obtained from the user. The user may select from the sets of fuel stops identified in Step 314. Alternatively, the user may specify one or more fuel stops.

In Step 318, the flight legs are established. As single flight leg may be established if no fuel stops are necessary. Multiple consecutive flight legs may be established if one or more fuel stops are required.

Turning to FIG. 4A, a flowchart describing a method for determining an estimated duration of a drive, in accordance with one or more embodiments of the disclosure, is shown.

In Step 400, an estimated duration of the drive is obtained based on prevailing conditions. Step 400 may be performed by an external service. For example, a network call to the external service may be issued using an API of the external service. The inputs to Step 400 may be the departure location, the destination location, and the departure time from the departure location, associated with the drive. Based on these inputs, an estimated arrival time or duration of the drive may be computed. Various factors, such as known traffic patterns, route preferences, etc., may be considered. The result returned is the estimated duration of the drive.

Turning to FIG. 4B, a flowchart describing a method for determining an estimated duration of a flight, in accordance with one or more embodiments of the disclosure, is shown. If a flight includes multiple legs, the method may be performed for each of the legs.

In Step 450, an estimated duration of the flight is obtained. The estimation may consider factors that may affect the duration of the flight, including prevailing flight conditions and aircraft characteristics. For example, the duration of the flight may be affected by distance, aircraft performance (including aircraft cruise profile, selected engine power settings), winds aloft, known weather phenomena that require detours, approach and departure procedures, airspace congestion, time for taxiing, time for fueling if necessary, etc. Those skilled in the art will appreciate that many factors may affect the duration of a flight. The estimation of the duration of the flight may be performed by a flight planning engine. Any information available to the flight planning engine may, thus, be considered when estimating the duration of the flight.

In Step 452, additional time may be added to the estimated duration. The additional time may accommodate preparing the aircraft for departure, parking and securing the aircraft, resting periods, etc.

Turning to FIG. 5, an example (500) of a multi-leg trip, in accordance with one or more embodiments of the disclosure, is shown. The example is used to illustrate two scenarios: a scenario 1 (550) in which an estimated arrival time at a destination location is obtained based on an initially provided desired departure time; and a scenario 2 (570) in which a recommended departure time is obtained based on an initially provided desired arrival time. While the example (500) illustrates a trip that includes three legs, embodiments of the disclosure are suitable for planning trips with any number of legs that are flyable and/or drivable. Similarly, while the illustrated trip is based on a specified departure location (510), and a specified destination location (540), intermediate stops may be specified as well, without departing from the disclosure.

In the example (500), a trip between a departure location (510) and a destination location (540) is shown. Assume that departure location (510) and destination location (540) were specified by a user. Using the steps described in FIG. 3, the legs connecting the departure location (510) and the destination location (540) are established. In the example, a leg 1 (512) connects the departure location (510) to a departure airport (520). A leg 2 (522) connects the departure airport (520) to the destination airport (530). Further, a leg 3 (532) connects the destination airport (530) to the destination location (540). Each of the legs (512, 522, 532) is associated with an estimated travel duration (514, 524, 534), that may be determined as described by the flowcharts of FIGS. 2A and 2B, 4A, and 4B.

Turning to scenario 1 (550) of FIG. 5, planning a trip in a forward direction is described. Assume that the user provided a desired departure time (552). As described in FIG. 2A, based on the desired departure time (552) at the departure location (510), an estimated arrival time (558) at the departure airport (520) is obtained. Next, an estimated departure time (554) at the departure airport (520) is obtained. The estimated departure time (554) may be the estimated arrival time (558), or it may be adjusted, e.g., to accommodate a layover. An estimated arrival time (560) at the destination airport (530) is obtained next and based on the estimated arrival time (560) an estimated departure time (556) is obtained. Eventually, an estimated arrival time (562) at the destination location (540) is obtained and may be reported to the user.

Turning to scenario 2 (570) of FIG. 5, planning a trip in a backward direction is described. Assume that the user provided a desired arrival time (572). As described in FIG. 2B, based on the desired arrival time (572) at the destination location (540), a predicted departure time (582) at the departure location (510) is obtained. Based on the guessed departure time (582), an estimated arrival time (588) at the departure airport (520) is obtained. Next, an estimated departure time (584) at the departure airport (520) is obtained. The estimated departure time (584) may be the estimated arrival time (588), or it may be adjusted, e.g., to accommodate a layover. An estimated arrival time (590) at the destination airport (530) is obtained next and based on the estimated arrival time (590) an estimated departure time (586) is obtained. Eventually, an estimated arrival time (592) at the destination location (540) is obtained. If the estimated arrival time (592) is sufficiently close to the desired arrival time (572), the predicted departure time (582) may be reported to the user as a recommended departure time. If the discrepancy between the estimated arrival time (592) and the desired arrival time (572) is too significant, a new predicted departure time (582) is selected to obtain a new estimated arrival time (592) that is close to the desire arrival time (572).

FIG. 6A shows an example of a user interface screen (600), in accordance with one or more embodiments. The example shows various content as it is collected by the method described in FIG. 3. The example (600) shows departure and destination locations (602) (as obtained in Step 300), and a desired departure/arrival time (604) (as obtained in Step 302). The example further shows the specification of an aircraft (606) (as obtained in Step 304), based on which the characteristics of the aircraft may be obtained. In addition, passenger data (610) (as obtained in Step 306), selected departure and destination airports (612) (as obtained in Step 312), possible departure and destination airports (614) (as obtained in Step 310) are shown. The example also shows map views (616) of the leg from the departure location to the departure airport and of the leg from the destination airport to the destination location.

FIG. 6B shows an example of a user interface screen (620), in accordance with one or more embodiments. The example shows various content as it is collected by the method described in FIG. 3. The example (620) shows a selected fuel loading scheme (622) (as obtained in Step 314), and possible fuel stops (624) (as obtained in Step 314). In addition, the example (620) shows a trip summary (626) prior to selection of the fuel stops.

FIG. 6C shows an example of a user interface screen (630), in accordance with one or more embodiments. In addition to the content shown in FIG. 6B, the example shows selected fuel stops (634) (as obtained in Step 316), and a complete trip summary (636) also showing the fuel stops.

Embodiments of the invention may be implemented on a computing system. Any combination of mobile, desktop, server, router, switch, embedded device, or other types of hardware may be used. For example, as shown in FIG. 7A, the computing system (700) may include one or more computer processors (702), non-persistent storage (704) (e.g., volatile memory, such as random access memory (RAM), cache memory), persistent storage (706) (e.g., a hard disk, an optical drive such as a compact disk (CD) drive or digital versatile disk (DVD) drive, a flash memory, etc.), a communication interface (712) (e.g., Bluetooth interface, infrared interface, network interface, optical interface, etc.), and numerous other elements and functionalities.

The computer processor(s) (702) may be an integrated circuit for processing instructions. For example, the computer processor(s) may be one or more cores or micro-cores of a processor. The computing system (700) may also include one or more input devices (710), such as a touchscreen, keyboard, mouse, microphone, touchpad, electronic pen, or any other type of input device.

The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the computing system (700) may include one or more output devices (708), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (702), non-persistent storage (704), and persistent storage (706). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system shown in FIG. 7A, or a group of nodes combined may correspond to the computing system shown in FIG. 7A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (700) may be located at a remote location and connected to the other elements over a network.

Although not shown in FIG. 7B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (722), node Y (724)) in the network (720) may be configured to provide services for a client device (726). For example, the nodes may be part of a cloud computing system. The nodes may include functionality to receive requests from the client device (726) and transmit responses to the client device (726). The client device (726) may be a computing system, such as the computing system shown in FIG. 7A. Further, the client device (726) may include and/or perform all or a portion of one or more embodiments of the invention.

The computing system or group of computing systems described in FIGS. 7A and 7B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 7A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query provided to a structured data repository (where the data repository may be organized according to a database schema or data format, such as XML).

The extracted data may be used for further processing by the computing system. For example, the computing system of FIG. 7A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 7A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 7A may include functionality to provide raw and/or processed data, such as results of comparisons and other processing. For example, providing data may be accomplished through various presenting methods. Specifically, data may be provided through a user interface provided by a computing device. The user interface may include a GUI that displays information on a display device, such as a computer monitor or a touchscreen on a handheld computer device. The GUI may include various GUI widgets that organize what data is shown as well as how data is provided to a user. Furthermore, the GUI may provide data directly to the user, e.g., data provided as actual data values through text, or rendered by the computing device into a visual representation of the data, such as through visualizing a data model.

For example, a GUI may first obtain a notification from a software application requesting that a particular data object be provided within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be provided through various audio methods. In particular, data may be rendered into an audio format and provided as sound through one or more speakers operably connected to a computing device.

Data may also be provided to a user through haptic methods. For example, haptic methods may include vibrations or other physical signals generated by the computing system. For example, data may be provided to a user using a vibration generated by a handheld computer device with a predefined duration and intensity of the vibration to communicate the data.

The above description of functions presents only a few examples of functions performed by the computing system of FIG. 7A and the nodes and/or client device in FIG. 7B. Other functions may be performed using one or more embodiments of the invention.

While the disclosed technology has been described with respect to a limited number of embodiments, those skilled in the art, having benefit of this disclosed technology, will appreciate that other embodiments can be devised which do not depart from the scope of the disclosed technology as disclosed herein. Accordingly, the scope of the disclosed technology should be limited only by the attached claims.

What is claimed is:

1. A method for planning a multi-leg trip, the method comprising:
obtaining, in a graphical user interface, trip data comprising a departure location, a departure airport, a destination airport, and a desired departure time;
selecting a first ground leg of the multi-leg trip, the first ground leg connecting the departure location to the departure airport;
obtaining a first estimated arrival time at the departure airport based on the desired departure time and the first ground leg;
selecting a flight leg of the multi-leg trip, the flight leg connecting the departure airport and the destination airport;
obtaining a second estimated arrival time at the destination airport based on:
the first estimated arrival time,
an aircraft to be used for the flight leg, and
a prevailing flight condition associated with the second flight leg; and
presenting, in the graphical user interface, the second estimated arrival time.

2. The method of claim 1, further comprising:
selecting a second ground leg of the multi-leg trip, the second ground leg connecting the destination airport and a destination location;
obtaining a third estimated arrival time at the destination location based on the second estimated arrival time and the second ground leg; and
reporting the third estimated arrival time at the destination location.

3. The method of claim 1, wherein obtaining the second estimated arrival time at the destination airport based on the first estimated arrival time comprises:
determining a flight duration from the departure airport to the destination airport based on a distance from the departure airport to the destination airport.

4. The method of claim 3, wherein determining the flight duration further comprises considering at least one selected from a group consisting of a performance of the aircraft, winds aloft, a weather phenomenon, approach and departure procedures, airspace congestion, taxiing, and fueling.

5. The method of claim 1, further comprising:
selecting the departure airport from a plurality of available departure airports based on at least one selected from a group of criteria consisting of:
a distance between the departure location and the departure airport,
operating hours of the departure airport,
fuel availability at the departure airport,
sufficient runway length at the departure airport for the aircraft,
an availability of a specified service at the departure airport, and
airport fees.

6. The method of claim 5, further comprising:
ranking the plurality of available departure airports based on at least one criterion of the group of criteria;
displaying, in the graphical user interface, an ordered list of the plurality of available departure airports, based on the ranking; and
obtaining, in the graphical user interface, a selection of the departure airport from the plurality of available departure airports in the ordered list.

7. The method of claim 1, further comprising:
making a determination that the flight leg requires a fuel stop; and based on the determination:
segmenting the flight leg into a first sub-leg and a second sub-leg,
wherein the second estimated arrival time further accounts for an additional time associated with the fuel stop.

8. The method of claim 7, further comprising:
selecting an intermediate airport for the fuel stop, based on at least one selected from a group of criteria consisting of: a preferred fuel loading scheme, fuel availability and cost, a runway characteristic, an availability of services, airport fees, and fuel tankering considerations.

9. The method of claim 8, wherein selecting the intermediate airport for the fuel stop comprises:
ranking a plurality of possible intermediate airports based on at least one of the group of criteria;
displaying, in the graphical user interface, an ordered list of the plurality of possible intermediate airports, based on the ranking; and
obtaining, in the graphical user interface, a selection of the intermediate airport from the plurality of possible intermediate airports in the ordered list.

10. A non-transitory computer readable medium comprising computer readable program code for causing a computer system to:
obtain, in a graphical user interface, trip data comprising a departure airport, a destination airport, a destination location and a desired arrival time;
obtain a first prediction of a departure time at the departure airport to arrive at the destination location at the desired arrival time;
calculate a first estimated arrival time at the destination location by:
selecting a flight leg of the multi-leg trip, the flight leg connecting the departure airport to the destination airport;
predicting an estimated arrival time at the destination airport based on:
the first prediction of the departure time at the departure airport,
an aircraft to be used for the flight leg, and
a prevailing flight condition associated with the flight leg;
selecting a ground leg of the multi-leg trip, the ground leg connecting the destination airport to the destination location;
predicting the first estimated arrival time at the destination location based on the estimated arrival time at the destination airport, and the ground leg;
determine an excessive discrepancy between the first estimated arrival time at the destination location and the desired arrival time, and based on the excessive discrepancy:
obtain a second prediction of the departure time at the departure airport, wherein the second prediction is made to reduce the discrepancy;
calculate a second estimated arrival time at the destination location based on the second prediction of the departure time; and
identify an acceptable discrepancy between the second estimated arrival time at the destination location and the desired arrival time; and based on the acceptable discrepancy:
present, in the graphical user interface, the second prediction of the departure time as a recommended departure time.

11. The non-transitory computer readable medium of claim 10, wherein the computer readable program code further causes the computer system to:
select the destination airport from a plurality of available destination airports based on at least one selected from a group of criteria consisting of:
a distance between the destination airport and the destination location,
operating hours of the destination airport,
fuel availability at the destination airport,
sufficient runway length at the destination airport for the aircraft,
an availability of a specified service at the destination airport, and
airport fees.

12. The non-transitory computer readable medium of claim 10, wherein the computer readable program code further causes the computer system to:
rank the plurality of available destination airports based on at least one criterion of the group of criteria;
display, in the graphical user interface, an ordered list of the plurality of available destination airports, based on the ranking; and
obtain, in the graphical user interface, a selection of the destination airport from the plurality of available destination airports in the ordered list.

13. The non-transitory computer readable medium of claim 10, wherein the computer readable program code further causes the computer system to:
make a determination that the flight leg requires a fuel stop; and based on the determination:
segment the flight leg into a first sub-leg and a second sub-leg,
wherein the estimated arrival time at the destination airport accounts for an additional time associated with the fuel stop.

14. The non-transitory computer readable medium of claim 13, wherein the computer readable program code further causes the computer system to:
select an intermediate airport for the fuel stop, based on at least one selected from a group of criteria consisting of: a preferred fuel loading scheme, fuel availability and cost, a runway characteristic, an availability of services, airport fees, and fuel tankering considerations.

15. The non-transitory computer readable medium of claim 14, wherein selecting the intermediate airport for the fuel stop comprises:
ranking a plurality of possible intermediate airports based on at least one of the group of criteria;
displaying, in the graphical user interface, an ordered list of the plurality of possible intermediate airports, based on the ranking; and
obtaining, in the graphical user interface, a selection of the intermediate airport from the plurality of possible intermediate airports in the ordered list.

16. A system for planning a multi-leg trip, the system comprising:
a computer processor;
a graphical user interface; and
instructions executing on the computer processor, causing the system to:
obtain, in the graphical user interface, trip data comprising a departure location, a departure airport, a destination airport, and a desired arrival time;
obtain a first prediction of a departure time at the departure location to arrive at the destination airport at the desired arrival time;
calculate a first estimated arrival time at the destination airport by:
selecting a ground leg of the multi-leg trip, the ground leg connecting the departure location to the departure airport;
predicting an estimated arrival time at the departure airport based on the first prediction of the departure time at the departure location and the ground leg;
selecting a flight leg of the multi-leg trip, the flight leg connecting the departure airport to the destination airport;
predicting the first estimated arrival time at the destination airport based on:
the estimated arrival time at the departure airport,
an aircraft to be used for the flight leg, and
a prevailing flight condition associated with the flight leg;
determine an excessive discrepancy between the first estimated arrival time at the destination airport and the desired arrival time, and based on the excessive discrepancy:
obtain a second prediction of the departure time at the departure location, wherein the second prediction is made to reduce the discrepancy;
calculate a second estimated arrival time at the destination airport based on the second prediction of the departure time; and
identify an acceptable discrepancy between the second estimated arrival time at the destination location and the desired arrival time; and based on the acceptable discrepancy:
present, in the graphical user interface, the second prediction of the departure time as a recommended departure time.

17. The system of claim 16, further comprises an aviation database,
wherein predicting the estimated arrival time at the destination airport comprises determining a flight duration from the departure airport to the destination airport based on a distance from the departure airport to the destination airport and based on a performance of the aircraft obtained from the aviation database.

18. The system of claim 16, further comprising a communication interface,
wherein predicting the estimated arrival time at the destination airport comprises determining a flight duration from the departure airport to the destination airport based on at least one selected from a group consisting of, winds aloft, a weather phenomenon, airspace congestion, and fueling information, obtained via the communication interface.

19. The system of claim 16, further comprising a GPS sensor,
wherein a current location, obtained by the GPS sensor is used to set the departure location.

20. The system of claim 16, further comprising:
an application programming interface configured to provide the planning the multi-leg trip to other system as a service.
